(19) United States
(12) Patent Application Publication
(10) Pub. No.: US 2012/0004025 A1
(43) Pub. Date: Jan. 5, 2012

(54) Game machine and program

(75) Inventor: Makoto Kaneko, Tokyo (JP)

(73) Assignee: KABUSHIKI KAISHA SEGA doing business as SEGA CORPORATION, Tokyo (JP)

(21) Appl. No.: 13/167,993

(22) Filed: Jun. 24, 2011

Related U.S. Application Data
(63) Continuation of application No. PCT/JP2009/069025, filed on Nov. 9, 2009.

(30) Foreign Application Priority Data
Dec. 26, 2008 (JP) 2008-334776

(51) Int. Cl. A63F 9/24; A63F 13/00

(52) U.S. Cl. 463/25; 463/31

(57) ABSTRACT

Disclosed is a game machine capable of raising game cycle execution frequency and increasing the enjoyment and fun of a game in loop play. A game machine includes: a game result determining part (82) for determining a game result for each game cycle; a game result displaying part (83, 30) for executing display of the game result for the game cycle; a loop play part (86) for executing loop play in which the game cycle is automatically repeated multiple times; and a display judging part (88) for judging whether or not a given display condition is satisfied for each game cycle in the loop play, in which: in a case of the game cycle judged by the display judging part (88) to have satisfied the display condition, the next game cycle is executed after executing the display of the game result; and in a case of the game cycle judged by the display judging part (88) to have failed to satisfy the display condition, the next game cycle is executed without executing the display of the game result.

### TECHNICAL FIELD

The present invention relates to a game machine and a program in which a game cycle is executed multiple times and a game result is determined for each game cycle.

### BACKGROUND ART

As conventional game machines installed in amusement facilities such as video arcades, casinos, and pachinko parlors, there have been known game machines in which a game cycle is executed multiple times and a game result is determined for each game cycle.

FIG. 9 is an explanatory diagram illustrating the exterior structure of a slot machine 100, which is one of the game machines described above.

The slot machine 100 includes a game medium insertion part 110 for dropping in a game medium such as real money or coin, an operation panel 120 for operations such as the setting of betting conditions, game result determining means (not shown) constituted of a computer or the like to determine a game result for each game cycle, a start lever 130 for issuing an instruction to start a game cycle, and a game result displaying device 140.

The game result displaying device 140 is constituted of a display window 141 and three reels 142 to 144, which are placed behind the display window 141 and which have various symbols arranged on circumferential surfaces. The reels 142 to 144 rotate in response to operation to the lever 130, and the symbols arranged on the reels 142 to 144 are thus dynamically (varyingly) displayed in the display window 141.

The game result determining means determines a game result by a lottery or the like that uses random numbers, or by other methods, at the time the lever 130 is operated, or at other appropriate times. After a game result is determined, the reels 142 to 144 stop at their respective rotation positions that conform to the game result, and the game result is displayed to a game player by way of a given number of symbols, arrangement of the symbols non-dynamically (stationarily) displayed in the display window 141 at this point. Thereafter, an amount of game medium determined for each game result is paid out to the game player.

A game cycle in the slot machine 100 described above begins with the operation to the lever 130 and ends with a non-dynamic display of symbols (a display of a game result), or a payout of the game medium.

The game cycle described above takes about several seconds to several tens seconds, and not many game players stop playing the game after executing this relatively short game cycle only once. Most game players play the game by repeating the game cycle tens of times, hundreds of times, or more.

In most variations of the slot machine 100, a game result is determined such that a value obtained by multiplying the accumulated amount of game medium that has been dropped in for each game cycle by a given payout rate equals the accumulated payout amount of game medium. Therefore, in order to improve the profit from the slot machine 100, it is desirable to make the game cycle execution frequency (the number of times a game cycle is executed within a unit time period) as high as possible.

A game player playing the game on the slot machine 100 also wants to execute the game cycle many times in most cases in hope of hitting the jackpot or other large wins, or acquiring a larger payout of the game medium. On the other hand, some game players feel that it is a bother to operate the start lever 130 each time the game cycle, which is repeated tens of times or hundreds of times, is executed.

US 2006/0287074 A1 discloses a slot machine that addresses the wishes described above.

In the slot machine of the publication cited above, an operation panel is provided with an operation member for issuing an instruction to execute a game cycle a given number of times in succession and, if a game player operates this operation member, the game cycle is automatically repeated for the subsequent given number of game cycles without requiring the game player to perform the game cycle starting operation (the act of operating the start lever 130 in the slot machine 100) (hereinafter, executing a game cycle automatically and repetitively multiple times without a starting operation being performed by the game player is referred to as “loop play”).

This slot machine thus saves the time required for the game player to perform the starting operation, raises the game cycle execution frequency accordingly, and removes the bother of performing the starting operation for each game cycle.
Patent Literature 1: US 2006/0287074 A1

### SUMMARY OF INVENTION

### Technical Problems

However, a large portion of the time required to complete a game cycle is taken up by the dynamic display and non-dynamic display of symbols, and the like. Therefore, just saving the time for the starting operation in each game cycle in loop play does not actually raise the game cycle execution frequency much.

Furthermore, although the slot machine of the patent literature cited above does removes a bother of a game player by eliminating the need for the starting operation, this simultaneously gives rise to a problem in that the reduced degree of participation in the game on the part of the game player lowers the interest and fun of the game and bores the game player.

The present invention has been made in view of the above-mentioned circumstances and achieves one or more of the following objects.

It is an object of the present invention to provide a game machine and a program which are capable of raising the game cycle execution frequency markedly.

It is another object of the present invention to provide a game machine and a program which are capable of increasing the enjoyment and fun of a game in loop play.

### Solution to Problems

In order to solve the above-mentioned problems, the present invention provides a game machine, including:
a game result determining part that determines a game result for each game cycle;
a game result displaying part that executes display of the game result for the game cycle;
loop play part that executes a loop play in which the game cycle is automatically repeated multiple times; and
a display judging part that judges whether or not a given display condition is satisfied for each game cycle in the loop play,
wherein the loop play part is configured to:
   in a case of the game cycle judged by the display judging part to have satisfied the display condition, execute the next game cycle after the game result displaying part executes the display of the game result; and
   in a case of the game cycle judged by the display judging part to have failed to satisfy the display condition, execute the next game cycle without executing the display of the game result (claim 1), or
a computer-readable storage medium recording a program to be executed in a computer installed in a game machine,
wherein, the game machine comprising:
a game result determining part that determines a game result for each game cycle; and
a game result displaying part that executes display of the game result for the game cycle,
wherein, the program makes the computer execute:
a loop play procedure of executing loop play in which the game cycle is automatically repeated multiple times; and
a display judging procedure of judging for each game cycle in the loop play whether or not a given display condition is satisfied,
wherein the loop play procedure comprises:
   in a case of the game cycle judged in the display judging procedure to have satisfied the display condition, executing the next game cycle after the game result displaying part executes the display of the game result; and
   in a case of the game cycle judged in the display judging procedure to have failed to satisfy the display condition, executing the next game cycle without executing the display of the game result (claim 8).

In the present invention, loop play for automatically repeating a game cycle multiple times is executed on the condition that a given operation is performed by a game player, and the game cycle execution frequency can therefore be raised.

The game cycle execution frequency can be raised even higher because the display of a game result is executed only for game cycles that are judged to have satisfied a display condition, and the display of a game result is omitted for other game cycles.

A “game method” of the present invention is a game method in which a game cycle including a step of determining a game result is executed multiple times, and a slot machine game can be given as an example thereof. A “program” of the present invention is a program capable of executing the above-mentioned “game method” on a computer.

A “game machine” of the present invention is a game machine capable of implementing the above-mentioned “game method”, and a slot machine can be given as an example thereof. The “game machine” of the present invention encompasses stand-alone computers capable of implementing the above-mentioned “game method”, and computer systems that provide the implementation of the above-mentioned “game method” via the Internet and other communication means.

A “game cycle” of the present invention refers to a game process executed repeatedly in the game machine or program of the present invention. The “game cycle” of the present invention can be constituted of just a single step (determination of a game result), or may include other steps (display of a game result, dynamic display of symbols, payout of a game medium, and the like) in addition to this step.

The specifics of a “game result” of the present invention can be determined arbitrarily. For instance, the hit/miss of a jackpot and other wins, and/or whether or not there has been a hit in a bonus game advantageous to the game player, and/or the amount of game medium paid out in the game cycle can be determined as the “game result”. Alternatively, what is displayed by the game result displaying part (for example, the respective stopped positions of the reels 142 to 144 in the slot machine 100 of FIG. 9, or symbols or combinations of symbols that are displayed non-dynamically on the symbol displaying device 140) may be determined as the “game result”.

The game result determining part of the present invention can determine a game result by an arbitrary method. Lottery that uses random numbers or the like can be given as an example of how a game result is determined. The execution of the game result determination according to the present invention can be timed with an arbitrary event, and a game result may be determined once, or multiple times, in a single game cycle.

“Display of a game result” of the present invention refers to enabling the game player to understand the game result, and how the “display of a game result” is executed is decided at discretion. For instance, a game result can be displayed visually as in the slot machine 100 of FIG. 9, or may be delivered acoustically by music or a fanfare, or may be delivered through a combination of visual effects and acoustic effects.

A “display condition” of the present invention can be set arbitrarily. For instance, whether or not the “display condition” is satisfied can be judged based on the game cycle execution count, such as judging that the “display condition” is satisfied when the number of times of the executed game cycles is an even number. Alternatively, a lottery for judging whether or not the “display condition” is satisfied may be conducted to judge that the “display condition” is satisfied when the result of the lottery is a win, and to judge that the “display condition” is not satisfied when the result of the lottery is a loss.

However, it is particularly preferred to judge whether or not the “display condition” is satisfied based on the “game result” of each game cycle (claim 2).

In this case, it is particularly preferred to judge that the “display condition” is satisfied when the “game result” advantageous to the game player (for example, the “game result” that involves the payout of a game medium) is determined. In this way, the “display of a game result” is omitted in the case of a game cycle for which the “game result” disadvantageous to the game player is determined, and the ratio of the time that can be spent to enjoy the “display of a game result” advantageous to the game player is increased. The interest and fun of the game are accordingly enhanced.

In the case where whether to execute the “display of a game result” depends on the combination of a plurality of symbols displayed non-dynamically, it may be judged that the “display condition” is satisfied when some of symbols belonging to a combination that represents the “game result” advantageous to the game player are displayed non-dynamically (when a “reach” state is entered), in addition to when the “game result” advantageous to the game player is determined. The “display of a game result” in this case builds up the anticipation of the game player for an advantageous “game result”.

Whether or not a display condition is satisfied can also be judged by combining some of the methods described above.

It is preferred for the present invention to further include a count displaying part that displays how many times the game cycle has been executed in the loop play (claim 3). The game player can thus easily recognize the progress of game cycles in loop play.

It is preferred for the present invention to further include a halt judging part that judges whether or not a given halting condition is satisfied, and when the halt judging part judges that the halting condition has been satisfied, it is preferred for the loop play to be halted (claim 4).

This aspect of the present invention may be structured such that loop play is halted on the condition that the game player performs a given operation, in order to enable the game player to quit playing at any point in loop play.

Alternatively, the invention may be structured such that loop play is halted on the condition that a specific game result such as a jackpot is determined. This enables the game player to end the game with a jackpot or the like as a trigger, or to take time in enjoying such a situation like a jackpot (for example, taking a photo to commemorate the occasion).

It is preferred for the present invention to further include: a winning recording part that records amounts of game medium to be paid out to the game player in association with a plurality of types of the game result; a payout part that pays out an amount of game medium that is recorded in the winning recording part in association with the game result of the game cycle; and a payout displaying part that displays at least one of a payout count and accumulated payout amount of game medium paid by the game medium payout part in the loop play, and it is preferred that the display judging part judge that the display condition is satisfied when the amount of game medium that is recorded in the winning recording part in association with the game result of the game cycle is a given amount (claim 5).

In this aspect of the present invention, the “display of a game result” is executed only for a game cycle in which a given amount of game medium is paid out, and the game cycle execution frequency can therefore be raised even higher.

Furthermore, while the present invention does not involve executing the “display of a game result” for a game cycle in which the given amount of game medium is not paid out, it is possible to make the game player trust or feel secure that the payout of the game medium is fair because the payout count and/or accumulated payout amount of game medium paid during loop play is displayed.

A “game medium” of the present invention is a medium paid out to the game player based on the game result. The “game medium” of the present invention may be real money, and may also be media other than real money such as medals and chips. The “game medium” does not always need to be a tangible medium and electronic data, for example, may be used as the “game medium”.

It is preferred for the present invention to further include: a game result recording part that records the game result for each game cycle in the loop play; a game cycle specifying part that receives specification of any of the executed game cycles in the loop play in accordance with an operation made by a game player; and a game result re-displaying part that executes display of the game result of the game cycle, the specification of which has been received by the game cycle specifying part (claim 6).

This aspect of the present invention allows the game player to re-check the game result of any game cycle executed in loop play. The game player can therefore repeatedly enjoy a game cycle that he/she has enjoyed during loop play. The game player can also check that the game medium has been paid out fairly, and is thus made to trust and feel secure about the game machine.

The game result re-displaying part may be structured to re-display the game result of a game cycle in loop play that has just been executed. Alternatively, it is possible to add a part that receives the specification of one of a plurality of rounds of loop play executed in the past, so that the game result of an arbitrary game cycle in the arbitrary loop play specified by the game player can be re-displayed.

It is preferred for the present invention to further include: a display mode recording part that records a plurality of types of modes of displaying the game result; and a display mode selecting part that selects one of the plurality of types of modes, and it is preferred that the game result displaying part execute the display of the game result in the mode that is selected by the display mode selecting part (claim 7).

Depending on the game result display mode, this aspect of the present invention can, for example, give the game player an anticipation for an advantageous game result.

### BRIEF DESCRIPTION OF DRAWINGS

FIG. 1 An explanatory diagram illustrating the exterior structure of a game machine according to an embodiment of the present invention.

FIG. 2 An explanatory diagram illustrating a game result displaying device.

FIG. 3 An explanatory diagram illustrating an operation panel.

FIG. 4 An explanatory diagram illustrating an information displaying panel.

FIG. 5 An explanatory diagram illustrating a display condition setting panel.

FIG. 6 An explanatory diagram illustrating the hardware structure of the game machine according to the embodiment of the present invention.

FIG. 7 A block diagram illustrating functions that are implemented in the game machine according to the embodiment of the present invention.

FIG. 8 A flow chart illustrating the flow of processing in loop play.

FIG. 9 An explanatory diagram illustrating the exterior structure of a conventional slot machine.

### DESCRIPTION OF EMBODIMENT

Hereinafter, an embodiment of the present invention is described by taking as an example a game machine 1, which is called a slot machine and installed in casinos, video arcades, pachinko parlors, and the like.

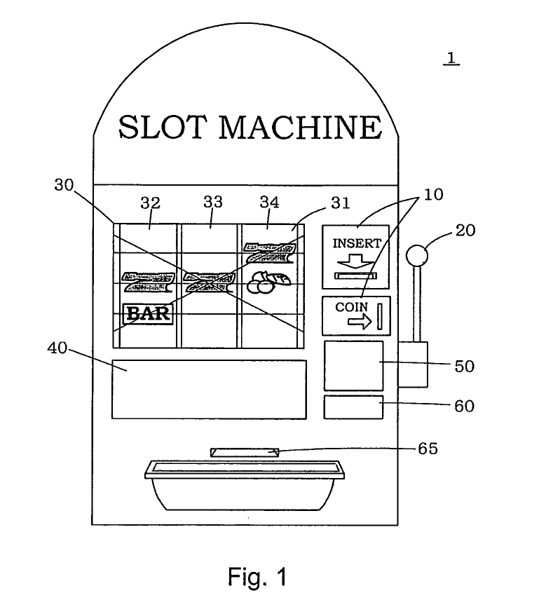

FIG. 1 is an explanatory diagram illustrating the exterior structure of the game machine 1 according to the present invention.

The game machine 1 includes, among others, a game medium insertion part 10 for dropping in a game medium, a start lever 20 for issuing an instruction to execute a single game cycle, a game result displaying device 30 for displaying the game result of each game cycle, an operation panel 40 for performing operations such as setting a game condition, an information displaying panel 50 for displaying various kinds of game information, a display condition setting panel 60 for setting a display condition, and a game medium payout part 65 for paying out a game medium in accordance with the game result.

In the game machine 1 of this embodiment, a currency (such as bill or coin) is used as a game medium, and dropping the currency into the game medium insertion part 10 credits an equivalent number of coins to the game machine 1. A game player uses the credited coins to play a game on the game machine 1.

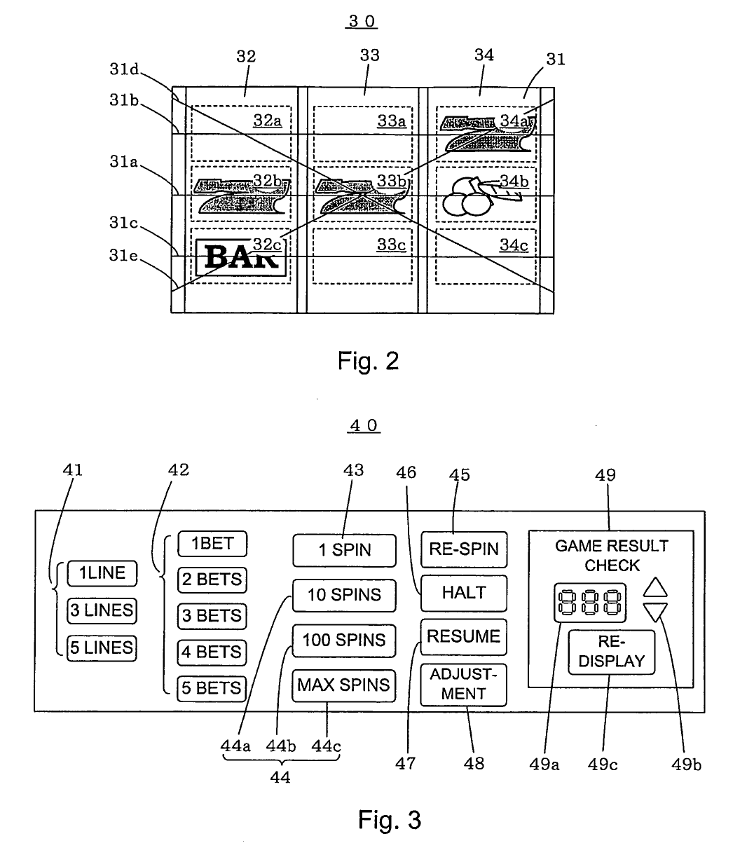

FIG. 2 is an explanatory diagram illustrating the game result displaying device 30 in an enlarged view.

As illustrated in the drawing, the game result displaying device 30 has a transparent display window 31 on a surface of which five judge lines (paylines) 31a to 31e are drawn.

Three rotatable reels 32 to 34 are placed behind the display window 31. Various symbols (including blank spaces in addition to such designs as “7”, “BAR”, and a picture of a cherry) are arranged at given angular intervals on circumferential surfaces of the reels 32 to 34. When the reels 32 to 34 come to a stop, one symbol is displayed non-dynamically at each of nine stopped positions 32a to 34c in the display window 31 which are indicated by frames of broken lines.

The game machine 1 of this embodiment displays a game result of each game cycle by showing what symbols are aligned along one of the judgment lines 31a to 31e that has been specified by the game player when the rotation of the reels 32 to 34 stops.

The game result displaying device 30 may be constituted of an image display such as a liquid crystal monitor in place of the display window 31 and the reels 32 to 34.

FIG. 3 is an explanatory diagram illustrating the operation panel 40 in an enlarged view.

In FIG. 3, line specifying buttons 41 and bet buttons 42 are operation members for specifying game conditions of each game cycle executed on the game machine 1.

Specifically, the line specifying buttons 41 are used for specifying which of the judge lines 31a to 31e is to be active. Selecting a “1 line” button enables one judge line, 31a. Selecting a “3 lines” button enables three judge lines, 31a to 31c. Selecting a “5 lines” button enables all the five judge lines 31a to 31e. However, in order to select the “3 lines” button, betting a number of coins twice larger than that for “1 line” is required, and selecting the “5 lines” button requires betting a number of coins three times larger than that for the “1 line”. In the following description, the judge lines 31a to 31e that are enabled by operating the line specifying buttons 41 are referred to as “active paylines”.

The bet buttons 42 are for specifying the number of coins to be bet for the active paylines 31a to 31e.

For instance, when a “2 bets” button is operated while the “1 line” button is selected, the number of coins bet in one game cycle (hereinafter, the number of coins bet in one game cycle is referred to as “total bet number TB”) is 2 and, if a combination of symbols for which a winning is defined falls on the active payline 31a, coins twice more than this winning are paid back to the game player.

Similarly, when a “3 bets” button is operated while the “3 lines” button is selected, the total bet number TB is 6 and, if a combination of symbols for which a winning is defined falls on one of the active paylines 31a to 31e, coins three times more than this winning are paid back to the game player.

A “1 spin” button 43 is a button to which a function similar to that of the start lever 20 is assigned. When the “1 spin” button 43 or the start lever 20 is operated, a single game cycle is executed under game conditions specified with the use of the line specifying buttons 41 and the bet buttons 42.

Loop play buttons 44 are buttons for executing loop play in which a game cycle is repeated multiple times under game conditions specified with the use of the line specifying buttons 41 and the bet buttons 42. When one of the loop play buttons 44 is operated, a game cycle is automatically and repeatedly executed without an operation made by the game player, until the game cycle execution for a specified number of times which is specified by this button operation is completed.

More specifically, ten times, a hundred times, and an infinite number of times of game cycles are executed by a single operation of a “10 spins” button 44a, a “100 spins” button 44b, and a “maximum spins” button 44c, respectively. However, loop play is terminated at the time when the game player's credit balance CB (a value obtained by subtracting the number of coins that have been bet in the previous game cycles from the sum of the number of coins equivalent to the amount of game medium dropped into the game medium insertion part 10 and the number of coins that have been paid out in the previous game cycles) becomes less than the total bet number TB.

During loop play, the operation of all operation members except a halt button 46, namely, operation members 20, 41 to 45, 47, 48, and 61a to 62c, is disabled.

A re-spin button 45 is a button for executing a single game cycle under the same game conditions as those of a game cycle that has been executed immediately before the current game cycle. The game player can therefore omit operating the line specifying buttons 41 and the bet buttons 42 by using the re-spin button 45.

The halt button 46 is a button for halting loop play. Conditions to be satisfied to halt loop play are arbitrary in the present invention. In this embodiment, however, halting conditions are satisfied when the halt button 46 is operated and when a jackpot (for example, the aligning of a combination of symbols for which a winning D of 3000 coins or more is defined with one of the active paylines 31a to 31e) occurs. When the halt button 46 is operated during loop play, loop play is halted upon completion of the game cycle that has been executed at that time.

In the case where the halt button 46 is operated again while loop play is halted, this round of loop play is terminated and the operation of the operation members 20, 41 to 45, 48, and 61a to 62c is enabled in order to receive an instruction to execute a new game cycle and other instructions from the game player.

A resume button 47 is a button, the operation of which is enabled only while loop play is halted. In the case where the resume button 47 is operated while loop play is halted, the loop play is resumed from the state immediately before the halt.

An adjustment button 48 is a button that is operated when the game player wishes to stop playing the game. When the adjustment button 48 is operated, a number of coins equivalent to the credit balance CB are paid out from the game medium payout part 65.

Disposed on a check panel 49 are operation members for re-displaying the game result of a specified game cycle in response to the specification of one of game cycles in loop play that has just been executed. Specifically, an up/down button 49b is used to increase or decrease a figure displayed in a count indication part 49a and then a re-display button 49c is operated, to thereby re-display on the game result displaying device 30 the game result of a game cycle that is specified by the figure displayed on the count indication part 49a. For example, when the re-display button 49c is operated with the count indicator 49a set to “30”, the game result of the thirtieth game cycle executed in the preceding loop play is re-displayed.

The game player can thus repeatedly enjoy an arbitrary game cycle executed in loop play, as many times as he/she desires. In addition, allowed to check the game result of an arbitrary game cycle after loop play ends, the game player will trust or feel secure that no error or deception has been made concerning the number of coins paid out in the loop play.

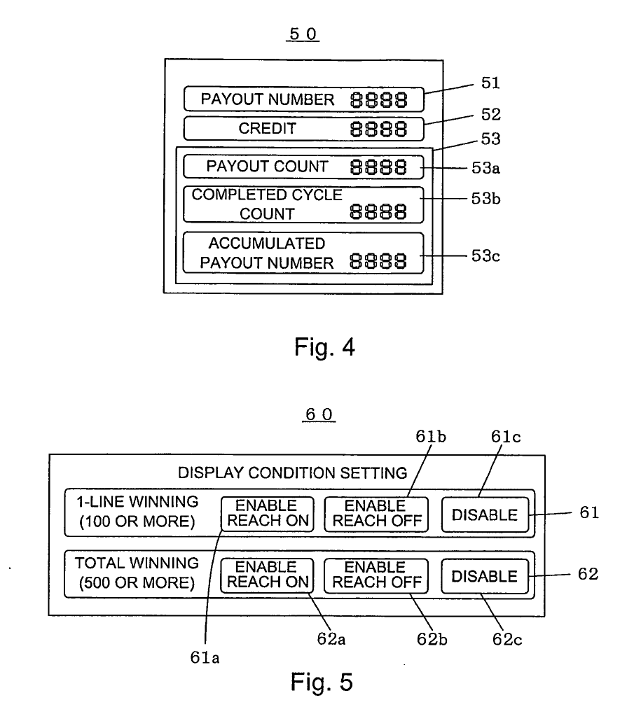

FIG. 4 is an explanatory diagram illustrating the information displaying panel 50 in an enlarged view.

As illustrated in the drawing, the information displaying panel 50 displays various kinds of information about a game executed on the game machine 1.

Specifically, a payout number indicator 51 displays, each time an individual game cycle ends, a total payout number TP, which is the total number of coins paid out in accordance with the game result of that game cycle. A credit indicator 52 displays the credit balance CB of the game player at that point.

Indicators for displaying game information about loop play are arranged on a loop play panel 53. A payout count indicator 53a displays a payout count PN, which is the number of game cycles in loop play in which one or more coins have been paid out. A completed cycle count indicator 53b displays an execution count (completed cycle count) FN, which is the number of times a game cycle has been executed since the start of loop play. An accumulated payout number indicator 53c displays an accumulated payout number IP, which is the accumulated number of coins paid out in loop play.

FIG. 5 is an explanatory diagram illustrating the display condition setting panel 60 in an enlarged view.

The display condition setting panel 60 is a panel for setting a condition (first condition) for displaying the game result of each game cycle in loop play, and has a first setting panel 61 and a second setting panel 62.

The first setting panel 61 is used for specifying whether to set as the first condition the aligning of a combination of symbols to which the winning D of a given number of coins (e.g., 100 coins) or more is defined (hereinafter, referred to as large-win combination“), or a “reach” combination thereof, with a single active payline out of the paylines 31a to 31e.

More specifically, in the case where a button 61a is selected on the first setting panel 61, it is judged that the first display condition is satisfied when a game result, in which a large-win combination is aligned with one of the active paylines 31a to 31e, is determined. In the case where a button 61b is selected, it is judged that the first display condition is satisfied when a game result, in which a large-win combination, or a “reach” combination thereof, is aligned with one of the active paylines 31a to 31e, is determined. In the case where a button 61c is selected, judgment of satisfaction of the first display condition depending on what combination of symbols is aligned with a single active payline out of the paylines 31a to 31e will not be carried out.

A “reach” combination of a combination of symbols means a combination that has a possibility of turning into that combination of symbols at the stage where the left reel 32 and the middle reel 33 have come to a stop and the right reel 34 has not stopped yet. For example, a “reach” combination of a combination of symbols “777” is “77-” (“-” is any other symbol than “7”).

The second setting panel 62 is used for specifying whether to set as the first condition the arrival of a total winning TD, which is the sum of the winnings D defined for combinations of symbols that fall on the respective active paylines 31a to 31e, at a given number of coins (e.g., 500 coins) or more, or the arrival of a “reach” state thereof (a state in which the total winning TD has a possibility of becoming equal to or more than the given number of coins at the stage where the left reel 32 and the middle reel 33 have come to a stop and the right reel 34 has not stopped yet).

More specifically, in the case where a button 62a is selected on the second setting panel 62, it is judged that the first display condition is satisfied when a game result, in which the total winning TD is to be equal to or more than the given number of coins, is determined. In the case where a button 62b is selected, it is judged that the first display condition is satisfied when a game result, in which the total winning TD is to be equal to or more than the given number of coins, or a game result for the reach state thereof, is determined. In the case where a button 62c is selected, judgment of satisfaction of the first display condition depending on the size of the total winning TD will not be carried out.

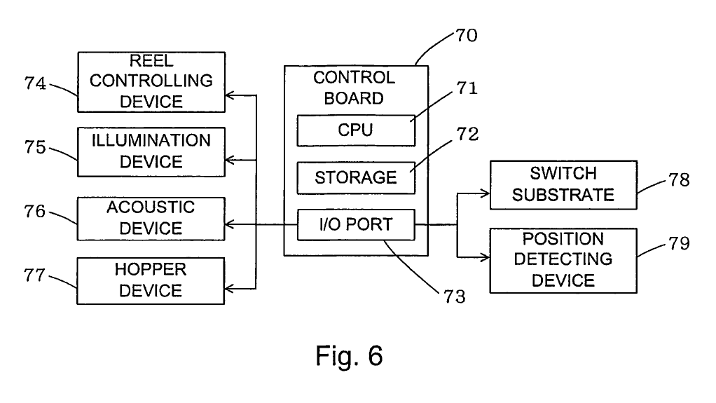

FIG. 6 is a block diagram illustrating the schematic structure of hardware installed in the game machine 1, and particularly illustrates a structure relevant to a control system.

As illustrated in the drawing, the game machine 1 has a built-in control board 70 on which a CPU 71, storage 72, an input/output port 73, and others are mounted.

The CPU 71 is a computing unit that performs overall control of the game machine 1 as the center of control operation of the game machine 1.

The storage 72 records programs and data necessary for the game machine 1 to operate. The storage 72 can be constituted of one of, or a combination of, known types of storage such as ROM, RAM, hard disk, and flash memory.

Various peripheral devices are connected to the control board 70 via the input/output port 73, and the CPU 71 exchanges signals with these peripheral devices in line with a program of the present invention which is recorded in the storage 72. Game processing described below is thus executed.

The above-mentioned peripheral devices include, among others, a reel controlling device 74 for driving the reels 32 to 34 to rotate, an illumination device 75 for illuminating the game machine 1, an acoustic device 76 for outputting sounds, a hopper device 77 for paying out to the game medium payout part 65 a number of coins equivalent to the credit balance CB when the adjustment button 48 is operated, a switch substrate 78 for detecting that the start lever 20 or the various operation members on the operation panel 40 have been operated, and a position detecting device 79 for detecting stopped positions (rotation positions) at which the reels 32 to 34 come to a stop.

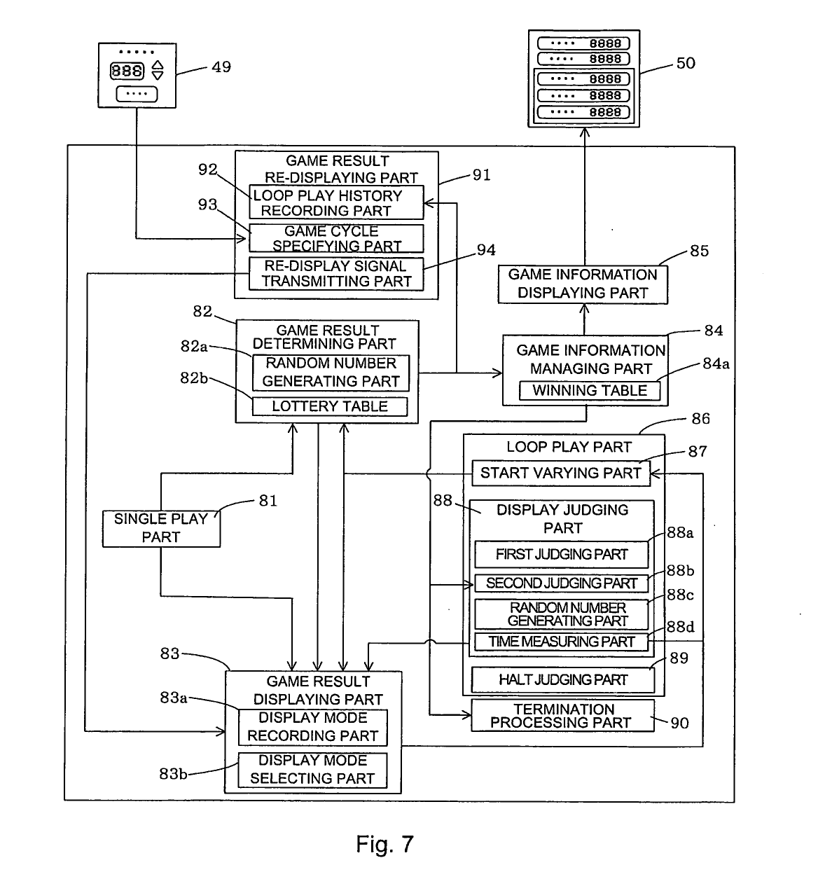

FIG. 7 is an explanatory diagram illustrating function blocks that are implemented in the game machine 1 by executing a program that the storage 72 stores by the CPU 71.

In the drawing, a single play part 81 is used for executing a game cycle once.

Specifically, the single play part 81 is put into operation upon detection of the fact that the start lever 20, the “1 spin” button 43, or the re-spin button 45 has been operated, and transmits a start signal to a game result determining part 82 and a game result displaying part 83.

The single play part 81 also measures a run time from the start of a game cycle (the transmission of the start signal), and waits for the elapse of a given symbol changing time T to transmit an end signal to the game result displaying part 83.

The game result determining part 82 includes a random number generating part 82a, which generates a given range of random numbers, and a lottery table 82b, which associates numerical values contained in the above-mentioned given range respectively with different types of predetermined game results. The game result determining part 82 determines a game result by checking a random number that is obtained at the time a start signal is received from the single play part 81 or from a start varying part 87 against the lottery table 82b.

The specifics of a game result and game result types can be set arbitrarily in the present invention. In the lottery table 82b of this embodiment, however, stopped positions (rotation positions) of the reels 32 to 34 are defined as a game result, and the respective stopped positions of the reels 32 to 34 that are associated with a random number generated by the random number generating part 82a are determined as a game result.

When the reels 32 to 34 stop at given stopped positions, the combination of symbols falling on each of the active paylines 31a to 31e is uniquely determined by the stopped positions. Therefore, it can also be said that the game result determining part 82 of this embodiment determines combinations of symbols that fall on the active paylines 31a to 31e as a game result.

A game result determined in the game result determining part 82 is notified to the game result displaying part 83 and a game information managing part 84.

The game result displaying part 83 executes dynamic display and non-dynamic display of symbols by controlling the rotation of the reels 32 to 34 via the reel controlling device 74.

Specifically, the game result displaying part 83 dynamically displays symbols in the display window 31 by rotating the reels 32 to 34 when receiving a start signal from the single play part 81 or from the start varying part 87. With the reception of an end signal from the single play part 81 or from a display judging part 88 as a trigger, the game result displaying part 83 stops the reels 32 to 34 respectively at rotation positions that conform to a game result determined by the game result determining part 82. Symbols are thus displayed non-dynamically at the stopped positions 32a to 34c in the display window 31, and the game player knows the game result by looking at the non-dynamically displayed symbols.

The game result displaying part 83 includes a display mode recording part 83a for recording a plurality of types of display modes and a display mode selecting part 83b for selecting one of those display modes. The dynamic display and/or non-dynamic display of symbols described above is performed in a display mode selected by the display mode selecting part 83b.

Display mode types and what standard is to be used to select from the display modes types can be set arbitrarily in the present invention. In the display mode recording part 83a of this embodiment, however, two display mode types are defined: one is a “normal mode” in which the reels 32 to 34 are stopped one after another at given time intervals (e.g., at 0.5-second intervals), and the other is a “reach mode” in which the first two reels, 32 and 33, are stopped in the same manner as in the “normal mode” whereas a longer time is set as a period before the last reel, 34, is stopped. The display mode selecting part 83b selects the “reach mode” in the case where a game result, in which a specific combination of symbols such as “777” or a reach combination thereof is to be displayed non-dynamically along one of the active paylines 31a to 31e, is determined, and selects the “normal mode” in other cases.

The game result displaying part 83 examines a signal from the position detecting device 79 to check whether or not the reels 32 to 34 have stopped in line with a game result notified from the game result determining part 82. If the reels 32 to 34 have not stopped at the correct stopped positions, the game result displaying part 83 halts game operation on the game machine 1 and executes error processing such as outputting alarm from the acoustic device 76.

The game information managing part 84 has a winning table 84a which defines the relation between a combination of symbols and a winning, and calculates the total payout number TP and others based on data of the winning table 84a, a game result determined in the game result determining part 82, and game conditions set via the operation panel 40.

Specifically, combinations of symbols that are respectively displayed non-dynamically along the active paylines 31a to 31e are identified based on a game result determined for each game cycle, and the identified combinations of symbols are checked against the winning table 84a, to thereby calculate the winnings D respectively for the active paylines 31a to 31e and the total winning TD, which is the sum of the winnings D. The total winning TD is multiplied by the number of coins bet via the bet buttons 42, to thereby calculate the total payout number TP.

The game information managing part 84 also executes processing of updating the credit balance CB each time a game cycle is executed and, during loop play, executes processing of updating the payout count PN, the completed cycle count FN, and the accumulated payout number IP each time a game cycle in loop play is executed.

A game information displaying part 85 executes processing of displaying on the information displaying panel 50 various kinds of game information managed in the game information managing part 84.

A loop play part 86 is used for executing loop play in which a game cycle is repeated a number of times that is set by operating the loop play buttons 44 (consecutive cycle execution count RN). The loop play part 86 includes the start varying part 87, the display judging part 88, a halt judging part 89, and a termination processing part 90.

When the “10 spins” button 44a, “100 spins” button 44b, and the “maximum spins” button 44c are operated, the consecutive cycle execution count RN is set to “10 times”, “100 times”, and “9999 times”, respectively.

The start varying part 87 executes a processing of transmitting a start signal to the game result determining part 82 and the game result displaying part 83 at the time the loop play buttons 44 are operated, and at the time a repeat signal is received from the game result displaying part 83 or from the display judging part 88.

The display judging part 88 includes a first judging part 88a, a second judging part 88b, a random number generating part 88c, and a time measuring part 88d.

The first judging part 88a judges whether to execute the display of a game result or not for each game cycle (judges whether or not the first display condition has been satisfied).

What conditions are to be satisfied to execute the display of a game result can be set arbitrarily in the present invention. The first judging part 88a of this embodiment, however, makes a decision about the matter described above based on what game result is determined by the game result determining part 82 and what conditions are set on the display condition setting panel 60.

More specifically, in the case where the button 61a or 61b is selected on the first setting panel 61, it is judged that the first display condition is satisfied when a game result, in which a large-win combination, or a reach combination thereof, is to be aligned with one of the active paylines 31a to 31e, is determined. In the case where the button 62a or 62b is selected on the second setting panel 62, it is judged that the first display condition is satisfied when a game result, in which the total winning TD is to be equal to or more than the given number of coins, or a game result for the reach state thereof is determined. In other cases, it is judged that the first display condition is not satisfied.

The second judging part 88b and the random number generating part 88c are optional components which can be additionally included in the game machine 1 of a particularly preferred mode, and make a supplementary decision about whether to execute the display of a game result or not (judge whether or not a second display condition has been satisfied).

Specifically, the second judging part 88b is put into operation when the first judging part 88a judges that the first display condition has not been satisfied, and uses the value of a random number generated by the random number generating part 88c to conduct a lottery. The second judging part 88b judges that the second display condition is satisfied when the result of the lottery is a win, and judges that the second display condition is not satisfied when the result of the lottery is a loss.

The winning odds of the lottery in the second judging part 88b can be, for example, approximately the same as the probability of the first judging part 88 judging that the first display condition is satisfied.

The game machine 1 of this embodiment thus judges that the display condition is satisfied in the case where one of the first display condition and the second display condition is satisfied, and judges that the display condition is not satisfied in the case where the first display condition and the second display condition both are not satisfied.

The time measuring part 88d measures the time elapsed since the transmission of a start signal from the start varying part 87, and executes processing of transmitting a repeat signal or an end signal when a symbol changing time T has passed.

More specifically, the time measuring part 88d transmits an end signal to the game result displaying part 83 in the case where it is judged that the display condition is satisfied, and transmits a repeat signal to the start varying part 87 in the case where it is judged that the display condition is not satisfied.

In a game cycle that follows a game cycle for which the display of the game result (non-dynamic display of symbols) has not been executed, the above-mentioned symbol changing time T can be shortened greatly because processing for starting the rotation of the reels 32 to 34 is unnecessary (the reels 32 to 34 only need to keep rotating).

The time measuring part 88d of this embodiment therefore measures a first changing time T1 as the symbol changing time T in the case where the display of the game result has been executed in the preceding game cycle, and measures a second changing time T2, which is shorter than the first changing time T1, as the symbol changing time T in the case where the display of the game result has not been executed in the preceding game cycle.

The halt judging part 89 judges whether or not a given halting condition is satisfied and, in the case where the halting condition is satisfied (when the halt button 46 is operated and when a jackpot occurs), executes processing of halting loop play.

When a halting condition is satisfied, the game machine 1 halts the game operation after completing a non-dynamic display of symbols that conforms to the game result of a game cycle in which the halt button 46 has been operated, or a game cycle in which a jackpot has occurred. If the resume button 47 is operated during this halted state, the loop play is resumed and operating the halt button 46 again terminates the loop play.

The termination processing part 90 executes processing of terminating loop play. Loop play is terminated in the case where the halt button 46 is operated while the loop play is in a halted state, in the case where the credit balance CB notified from the game information managing part 84 becomes less than the total bet number TB, and in the case where executing a game cycle a number of times that is set as the consecutive cycle execution count RN by operating the loop play buttons 44 is completed. Thereafter, the operation of the operation members 20, 41 to 45, 48, 61a to 62c is enabled.

In the case where the credit balance CB becomes less than the total bet number TB and in the case where executing a game cycle a number of times that is set as the consecutive cycle execution count RN is completed, the termination processing part 90 terminates loop play after a non-dynamic display of symbols that conforms to the game result of the preceding game cycle is completed.

A game result re-displaying part 91 re-displays the game result of an arbitrary game cycle in loop play that has just been executed in line with an operation made on the check panel 49.

Specifically, the history of game results determined by the game result determining part 82 for the respective game cycles in loop play is recorded in a loop play history recording part 92, and a game cycle specifying part 93 identifies a game cycle wished by the game player to be re-displayed based on the operation to the check panel 49. A re-display signal transmitting part 94 extracts the game result of the identified game cycle from the loop play history recording part 92 and transmits the game result to the game result displaying part 83 to have the game result displaying part 83 execute the display of the game result on the game result displaying device 30.

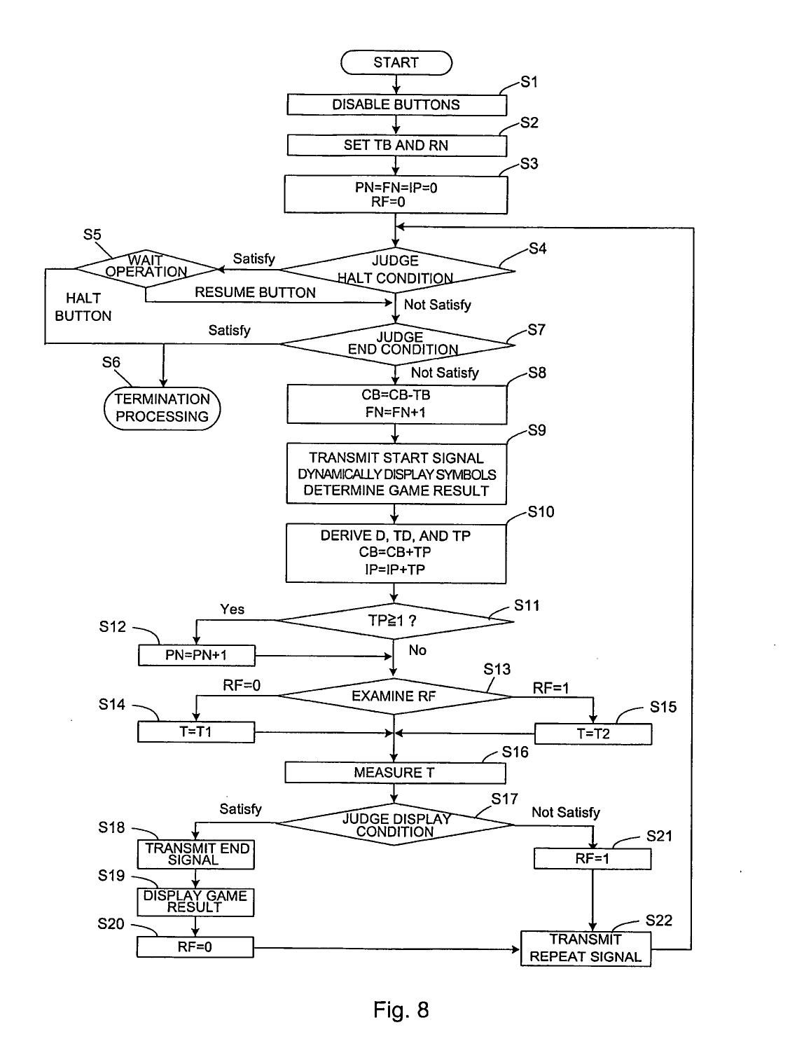

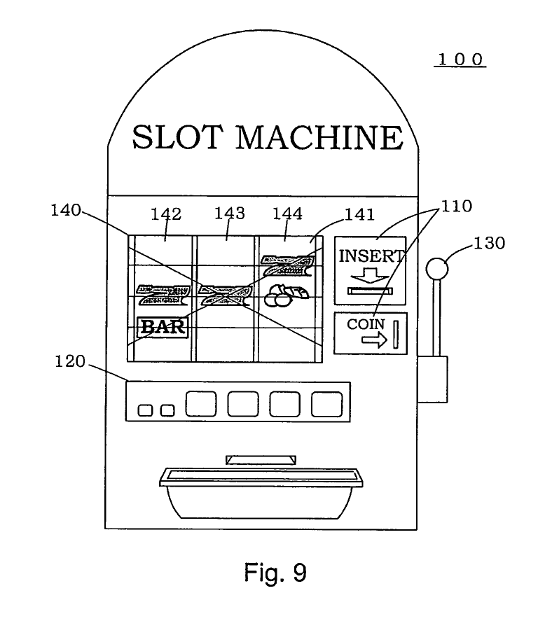

FIG. 8 is a flow chart illustrating details of loop play processing that is executed when the loop play buttons 44 are operated on the game machine 1.

When the loop play processing is started, processing of disabling the operation of the operation members 20, 41 to 45, 48, and 61a to 61c (Step S1) is executed. Executed next is processing of setting the total bet number TB based on an operation made with the line specifying buttons 41 and the bet buttons 42, and setting the consecutive cycle execution count RN based on an operation made with the loop play buttons 44 (Step S2). Loop play information such as the payout count PN, the completed cycle count FN, and the accumulated payout number IP is subsequently initialized, as well as a rotation flag RF, which indicates the rotation status of the reels 32 to 34 (Step S3).

In the following Step S4, whether or not a halting condition is satisfied is judged. Specifically, it is judged that a halting condition is satisfied in the case where the halt button 46 has been operated during a game cycle that has been executed immediately before the current game cycle (Steps S7 to S22), and in the case where a game result determined in the preceding Step S9 is a jackpot. The processing moves to Step S5 in the case where it is judged that the halting condition is satisfied, and to Step S7 in other cases.

In Step S5, the processing is on standby until the halt button 46 or the resume button 47 is operated. In the case where the halt button 46 is operated, the termination processing part 90 executes processing of terminating loop play (Step S6), whereas the processing moves to Step S7 in the case where the resume button 47 is operated.

In Step S7, whether or not an ending condition is satisfied is judged. It is judged that an ending condition is satisfied and the processing moves to Step S6 in the case where the credit balance CB is less than the total bet number TB, and in the case where the completed cycle count FN is equal to the consecutive cycle execution count RN.

In the case where it is judged in Step S7 that an ending condition is not satisfied, processing of updating the credit balance CB and the completed cycle count FN is executed in Step S8. Specifically, the total bet number TB is subtracted from the credit balance CB and “1” is added to the completed cycle count FN.

In the following Step S9, a start signal is transmitted from the start varying part 87, which causes the game result displaying part 83 to execute dynamic display of symbols. Specifically, in the case where the reels 32 to 34 are in a stationary state (in the case where the rotation flag RF is “0”), the rotation of the reels 32 to 34 is started, whereas processing of maintaining rotation is executed in the case where the reels 32 to 34 are rotating (in the case where the rotation flag is “1”). The game result determining part 82 concurrently executes the determination of a game result.

In Step S10, the game information managing part 84 is put into operation to derive the respective winnings D of the active paylines 31a to 31e, the total winning TD which is the sum of the winnings D, and the total payout number TP, based on the game result determined in Step S9. Processing of adding the total payout number TP to each of the credit balance CB and the accumulated payout number IP is also executed.

In Step S11, whether or not the total payout number TP of Step S10 is 1 or more is judged. In the case where TP is 1 or more, the processing moves to Step S13 after processing of updating the payout count PN (Step S12) is executed. In the case where TP is less than 1, the processing moves to Step S13 without executing the updating processing.

In Step S13, the rotation flag RF is examined. In the case where RF is “0”, processing of setting the symbol changing time T to the first changing time T1 is executed (Step S14). In the case where RF is “1”, processing of setting the symbol changing time T to the second changing time T2 is executed (Step S15).

In the following Step S16, the time measuring part 88d executes timekeeping processing. Specifically, the time elapsed since the transmission of the start signal in Step S9 is measured and the processing moves to Step S17 when the symbol changing time (the first changing time T1 or the second changing time T2) has passed.

Step S17 is a step for judging whether or not a display condition is satisfied, and the first judging part 88a and the second judging part 88b judge whether or not the first display condition and the second display condition are satisfied. In the case where one of the first display condition and the second display condition is satisfied, it is judged that a display condition is satisfied and the processing moves to Step S18.

In Step S18, an end signal is transmitted from the time measuring part 88d to the game result displaying part 83. With the reception of the end signal as a trigger, the game result displaying part 83 executes the display of a game result (Step S19).

Specifically, the reels 32 to 34 are respectively stopped at rotation positions that conform to the game result determined in Step S9, and nine symbols that conform to this game result are displayed non-dynamically in the display window 31.

After the display of the game result is completed, processing of setting the rotation flag RF to “0” is executed (Step S20).

On the other hand, in the case where it is judged in Step S17 that a display condition is not satisfied, processing of setting the rotation flag RF to “1” is executed in Step S21.

After Step S20 or S21, the processing moves to Step S22 to execute processing of transmitting a repeat signal to the start varying part 87 from the game result displaying part 83 or from the time measuring part 88d. This completes one game cycle, and the processing returns to Step S4 in order to execute the next game cycle.

In the game machine 1 described above, the display of a game result (Step S19) is executed only when it is judged in Step S17 that a display condition is satisfied, and the game cycle execution frequency in loop play can therefore be raised markedly.

For instance, when the first changing time T1 and the second changing time T2 are each 5 seconds and an average of the time required to display a game result is 10 seconds, a conventional game machine which displays a game result for every game cycle requires 1,500 seconds for loop play involving 100 game cycles.

In the game machine 1 of this embodiment, on the other hand, when the probability of a display condition being satisfied is 20%, for example, loop play involving 100 game cycles takes 800 seconds, and the time required for the loop play is thus cut to approximately half that of the conventional game machine.

The game machine 1 of this embodiment is also capable of setting the symbol changing time T (second changing time T2) short in a game cycle that is started while the reels 32 to 34 are rotating (a game cycle, in which the rotation flag RF in Step S13 is “1”). For example, when the second changing time T2 is set to 1 second, loop play that involving 100 game cycles takes 280 seconds, and the time required for the loop play is thus cut to approximately ⅕ of that of the conventional game machine.

Furthermore, the game machine 1 of this embodiment gives a game player a greater anticipation for the display of a game result than in prior art by setting suitable winning odds in the second judging part 88b, because, in the case where the display of a game result (Step S19) is to be executed, a game result, in which a large-win combination or a reach combination thereof is aligned with one of the active paylines 31a to 31e, or a game result in which the total winning TD is equal to or more than a given number of coins (e.g., 500 coins) or a game result for the reach state thereof is determined with a considerably high rate.

In addition, with the game machine 1 of this embodiment where the time required to execute loop play is cut short, the ratio of the time spent for the display of a game result which can thus be enjoyed with a great anticipation is significantly increased, thereby enhancing the interest and fun of the game markedly.

In the game machine 1 of this embodiment, while the game result is not displayed for a game cycle judged not to satisfy a display condition, the game player can fully recognize the overview of the game results of the respective game cycles and the progress of game cycles from what is displayed on the loop play panel 53.

Moreover, because the game result of any game cycle executed during loop play can be checked with the use of the check panel 49 after the loop play is finished, the game player will trust or feel secure that no error or deception has been made concerning the number of paid out coins.

The present invention has thus been described through an exemplary embodiment. However, the present invention is not limited by the embodiment described above, and various changes and modifications can be made within the scope of claims.

For instance, in the embodiment described above, the present invention is applied to a slot machine and a program for a slot machine, the present invention is also applicable to other types of game machines and programs in which a game cycle is executed multiple times and a game result is determined for each game cycle.

In the embodiment described above, loop play is executed or halted when the game player performs a given operation (the act of operating the loop play buttons 44 or the halt button 46), and the judgment of whether a halting condition is satisfied or not and the selection of a halt mode are performed based on the game result. This, however, is merely a particularly preferred example of the present invention. The present invention may instead be structured such that loop play is executed or halted when other conditions are satisfied, and may also be structured such that the judgment of whether a halting condition is satisfied or not and the selection of a halt mode are based on other factors.

In the embodiment described above, the game machine 1 allows a game player to set a display condition with the use of the display condition setting panel 60.

The present invention may also be structured such that a display condition can be set only by, for example, the manufacturer of the game machine 1 or the manager of an amusement facility where the game machine 1 is installed.

In the embodiment described above, two types of display modes are set and selection of the display modes in accordance with the game result is made in advance. However, three or more display mode types may be set, and the present invention may be structured in a manner that allows the game player, the manufacturer, and/or the manager of the amusement facility to set which play mode is selected for which game result.

A “game cycle” in the embodiment described above is constituted of a series of processes from the judgment of whether an ending condition is satisfied or not (Step S7) to the transmission of a repeat signal (Step S22). However, a “game cycle” in the present invention or in the embodiment described above does not need to be interpreted as such. For instance, a “game cycle” in the embodiment described above may be interpreted as being constituted solely of the “game result determination” of Step S9.

The device structures, the function structures, the processing specifics, the modes of displaying game results and other types of information, and the like in the embodiment described above are given merely as examples, and the present invention is not limited thereto.

### REFERENCE SIGNS LIST

1 . . . game machine, 10 . . . game medium insertion part, 20 . . . start lever, 30 . . . game result displaying device, 40 . . . operation panel, 49 . . . check panel, 50 . . . information displaying panel, 53 . . . loop play panel, 60 . . . display condition setting panel, 65 . . . game medium payout part, 70 . . . control board, 71 . . . CPU, 72 . . . storage, 73 . . . input/output port, 74 . . . reel controlling device, 75 . . . illumination device, 76 . . . acoustic device, 77 . . . hopper device, 78 . . . switch substrate, 79 . . . position detecting device, 81 . . . single play part, 82 . . . game result determining part, 83 . . . game result displaying part, 84 . . . game information managing part, 85 . . . game information displaying part, 86 . . . loop play part, 87 . . . start varying part, 88 . . . display judging part, 89 . . . halt judging part, 90 . . . termination processing part, 91 . . . game result re-displaying part, 92 . . . loop play history recording part, 93 . . . game cycle specifying part, 94 . . . re-display signal transmitting part

1. A game machine, comprising:
a game result determining part that determines a game result for each game cycle;
a game result displaying part that executes display of the game result for the game cycle;
a loop play part that executes a loop play in which the game cycle is automatically repeated multiple times; and
a display judging part that judges whether or not a given display condition is satisfied for each game cycle in the loop play,
wherein the loop play part is configured to:
in a case of the game cycle judged by the display judging part to have satisfied the display condition, execute the next game cycle after the game result displaying part executes the display of the game result; and
in a case of the game cycle judged by the display judging part to have failed to satisfy the display condition, execute the next game cycle without executing the display of the game result.

2. A game machine according to claim 1, wherein the display judging part judges whether or not the display condition is satisfied based on the game result determined for each game cycle.

3. A game machine according to claim 1, further comprising a count displaying part that displays how many times the game cycle has been executed in the loop play.

4. A game machine according to claim 1, further comprising a halt judging part that judges whether or not a given halting condition is satisfied,
wherein, when the halt judging part judges that the halting condition has been satisfied, the loop play part halts the loop play.

5. A game machine according to claim 1, further comprising:
a winning recording part that records amounts of game medium to be paid out to a game player in association with a plurality of types of the game result;
a payout part that pays out an amount of game medium that is recorded in the winning recording part in association with the game result of the game cycle; and
a payout displaying part that displays at least one of a payout count and accumulated payout amount of game medium paid by the game medium payout part in the loop play,
wherein the display judging part judges that the display condition is satisfied when the amount of game medium that is recorded in the winning recording part in association with the game result of the game cycle is a given amount.

6. A game machine according to claim 1, further comprising:
a game result recording part that records the game result for each game cycle in the loop play;
a game cycle specifying part that receives specification of any of the executed game cycles in the loop play in accordance with an operation made by a game player; and
a game result re-displaying part that executes display of the game result of the game cycle, the specification of which has been received by the game cycle specifying part.

7. A game machine according to claim 1, further comprising:
a display mode recording part that records a plurality of types of modes of displaying the game result; and
a display mode selecting part that selects one of the plurality of types of modes,
wherein the game result displaying part executes the display of the game result in the mode that is selected by the display mode selecting part.

8. A computer-readable storage medium recording a program to be executed in a computer installed in a game machine,
wherein, the game machine comprising:
a game result determining part that determines a game result for each game cycle; and
a game result displaying part that executes display of the game result for the game cycle,
wherein, the program makes the computer execute:
a loop play procedure of executing a loop play in which the game cycle is automatically repeated multiple times; and
a display judging procedure of judging for each game cycle in the loop play whether or not a given display condition is satisfied,
wherein the loop play procedure comprises:
in a case of the game cycle judged in the display judging procedure to have satisfied the display condition, executing the next game cycle after the game result displaying part executes the display of the game result; and
in a case of the game cycle judged in the display judging procedure to have failed to satisfy the display condition, executing the next game cycle without executing the display of the game result.
